(19) United States
(12) Patent Application Publication
(10) Pub. No.: US 2008/0052926 A1
(43) Pub. Date: Mar. 6, 2008

(54) Gravity dial level indicator for line generator

(75) Inventors: Thomas M. Parel, Anderson, SC (US); Robert E. McCracken, Anderson, SC (US)

Correspondence Address: BRINKS HOFER GILSON & LIONE, P.O. BOX 10395, CHICAGO, IL, 60610, US

(73) Assignee: Eastway Fair Company Limited

(21) Appl. No.: 11/515,674

(22) Filed: Sep. 5, 2006

(51) Int. Cl. G01C 15/00

(52) U.S. Cl. 33/286

(57) ABSTRACT

A line generator includes a housing carrying a light source for emitting a light beam and a mounting surface for removably mounting the generator on a surface. The line generator includes a gravity dial having at least one indicator, wherein when the mounting surface is substantially vertical, the gravity dial will self level under the influence of gravity and the at least one indicator will indicate whether the emitted light beam is in a predetermined orientation selected from one of a vertical line or a horizontal line.

The present invention relates to a gravity dial level indicator for a line generator and in particular to a laser level line generator.

### BACKGROUND

Laser levels typically seek to produce a plane of light for a reference for construction projects. Laser levels may save time during initial layout of a construction job compared to other tools such as beam levels, chalk lines, or torpedo levels. Some examples of jobs where laser levels would be useful include laying tile, mounting cabinets, installing counter tops, and building outdoor decks. Commonly, laser levels are provided with bubble or spirit levels to assist in leveling the housing containing the light source so that the emitted beam is oriented in a desired direction. Bubble levels, however, may be difficult to use and see. It is therefore an object of the present invention to provide a laser level that is inexpensive and usable by the general public.

### SUMMARY

The present invention provides a gravity dial for a line generator that is removably disposable on a surface. The leveling line generator includes a housing that carries a light source that emits a planar light beam. The housing includes a mounting surface for removably mounting the generator on a surface and a viewable surface opposite the mounting surface and provided with a gravity dial. The gravity dial includes a weighted disc and a stationary ring surrounding the disc. The weighted disc includes at least one indicator and the stationary ring includes at least one indicator. When the mounting surface is substantially vertical, the weighted disc will self level under the influence of gravity and the at least one indicator on the weighted disc will align with at least one indicator provided on the stationary ring to provide an indication that the emitted planar beam is in a predetermined orientation selected from one of a vertical line or a horizontal line.

Additional features and benefits of the present invention are described, and will be apparent from, the accompanying drawings and the detailed description below.

### BRIEF DESCRIPTION OF THE DRAWINGS

FIG. 1 is a perspective view of one embodiment of a laser level incorporating the self-leveling line generator according to the present invention.

FIG. 2 is a top view of the laser level of FIG. 1.

FIG. 3 is a perspective view of the second housing of FIG. 1 with a top portion removed to better show features contained within the housing.

FIG. 4 is a perspective view of the laser level of FIG. 1 with the top portion removed and with certain features removed to better illustrate the self-leveling line generator.

FIG. 5 is a cross sectional view of the first housing shown in FIG. 4 along line 4-4.

FIG. 6 is a partially exploded view of the first housing shown in FIG. 4.

FIG. 7 is a side perspective and exploded view of the first housing show in FIG. 4 with certain features not shown to better illustrate the invention.

FIG. 8 is a rear view of the device shown in FIG. 7

FIG. 9 is a front view of another embodiment of a laser level incorporating the self-leveling line generator according to the present invention.

FIG. 10 is a side view of the laser level of FIG. 9.

FIG. 11 is a cut-away view of the laser level of FIG. 9 to illustrate certain features of the present invention.

FIG. 12 is an exploded view of the laser level of FIG. 9.

### DESCRIPTION

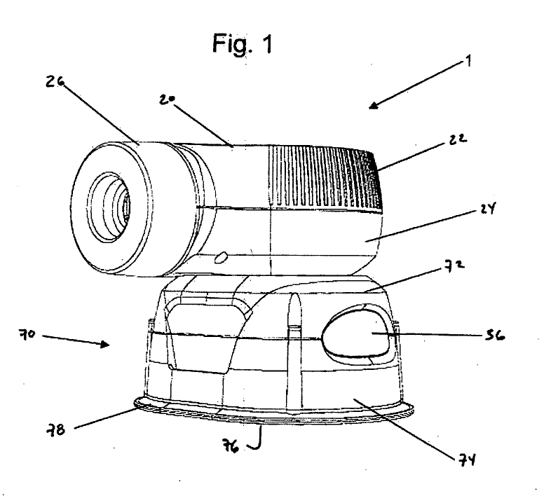

Turning now to FIG. 1, one embodiment of a laser level 1 incorporating the self-leveling line generator 10 according to the present invention is shown. In this embodiment, the laser level 1 is capable of being mounted on a surface so that the projected planar beam is in a fixed orientation which is one of a vertical or a horizontal direction.

In this embodiment, the line generator 10 includes a first housing 20 that is pivotable or rotatable with respect to a second housing 70. The first housing 20 may be formed from two clam shell like portions with a first portion 22 and a second portion 24 such as a top and bottom portion or a right and left side. Likewise, the second housing 70 may be formed from two clam shell like portions with a first portion 72 and a second portion 74 such as a top and bottom portion or a right and left side. The first housing 20 may be freely rotatable with respect to the second housing 70. The first housing 20 may pivot with respect to the second housing 70 about an arc from about 1° to greater than about 360°. Alternatively, the first housing 20 may be rotatably limited to about 360° or some other smaller arc, depending on desired preferences. For example, the first housing 20 may be rotatably limited to a 90° position from a reference position. Alternatively, the first housing 20 may be freely pivotable but may have temporary stops such as detents or the like at one more desired positions such as at 90°, 180°, or other positions from a reference position.

The first housing 20 contains at least one light source 30 that is positionally fixed with respect to the first housing 20. In addition, as shown in FIG. 1, the first housing 20 may include a barrel 26 containing a lens 32. The barrel 26 may also contain the light source 30. As will be discussed in more detail below, the lens 32 is rotatable with respect to light source 30. The laser level 1 contains a power source 34 for providing power to the light source 30. Desirably, the light source 30 is a laser diode that emits a beam of light that is received by the lens 32 which converts the beam into a planar light beam that is emitted from the line generator 10.

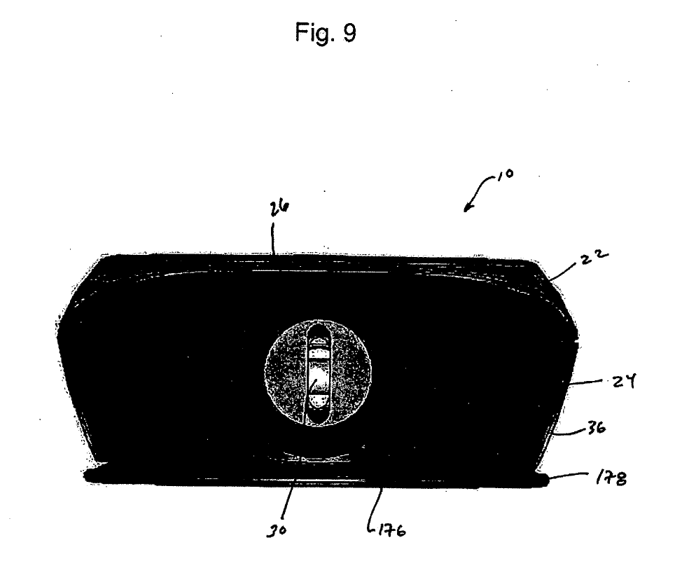

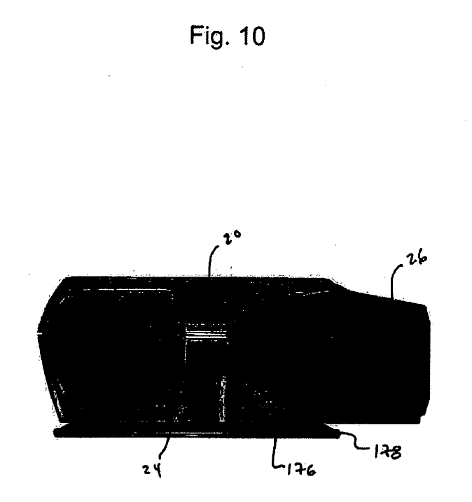

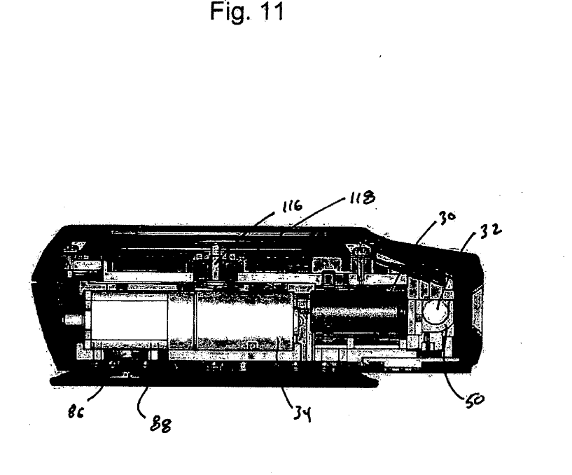

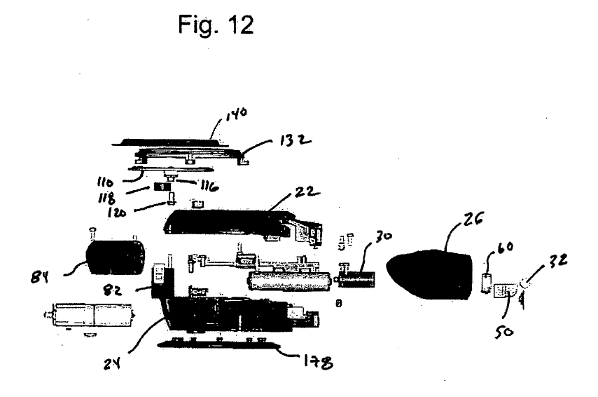

The second housing 70 includes a mounting surface 76 for mounting the line generator 10 to a surface. Alternatively and as shown in FIGS. 9-12, the bottom portion of the first housing may include a mounting surface 176. In this alternative, there is no second housing and thus, one is not present. In any event, the mounting surface 76,176 may be configured to cooperate with known mounting structures such as adhesive tape (removable or otherwise), nails, brackets, magnets, etc. In the embodiment shown in FIG. 1, the mounting surface 76 includes a mounting seal 78, 178 extending from a lower portion of the bottom portion 74, 174 to define a suction mounting area.

The mounting seal 78,178 has sufficient flexibility and resilience so that when the line generator 10 is pressed toward a surface, the mounting seal 78,178 will deform to create a vacuum within a cavity defined by the mounting seal. The mounting seal 78, 178may be a rubber seal that extends from a lower portion of the housing about the cavity. Other elastomeric materials may be used to accomplish the objective of being deformable to provide a seal.

The line generator 10 may include a vacuum generating mechanism 80 that cooperates with the mounting seal 78,178 to create a vacuum in the suction mounting area. The vacuum generating mechanism 80 may include a motor 82 disposed within the housing. A vacuum pump 84 is operatively connected to the motor 82 and is mounted adjacent the motor 82 in the housing. It is also understood that the motor 82 and the pump 84 may be assembled as a single unit. The inlet of the pump 82 is connected to an aperture 88 on the bottom of the housing to provide a flow of air from the cavity defined by the mounting seal 78, 178 and the attachment surface. The pump 84 cooperates with the mounting seal 78, 178 to create a vacuum between the attachment surface and housing to mount the line generator 10 in a fixed relationship relative to the attachment surface.

A power source 34 is provided to provide power for the motor 82. Desirably, the power source 34 for the motor 82 also provides power for the light source 30. Desirably, the housing has a user accessible cavity to permit access to a power source 34 such as batteries (which may be rechargeable or not). The motor 82 may be activated by a switch 90, 190 located on an outer surface of the housing. In use, the mounting seal 78, 178 is pressed to an attachment surface and the motor 82 can be activated by actuating the switch 78, 178 allowing the pump to 84 evacuate air from the suction mounting area created between the attachment surface and the mounting seal 78, 178 through the aperture 88.

A sensor may be provided proximate the mounting seal 78, 178 to monitor the vacuum pressure in the suction mounting area. The sensor may activate the pump 84 to remove air from the suction mounting area when the sensor detects a loss of vacuum pressure in the area between the mounting seal 78, 178 and the attachment surface. Loss of vacuum pressure in the suction mounting area may be caused by imperfections in the attachment surface, such as gaps or cracks that limit the effectiveness of mounting seal 78, 178. The sensor allows the pump 84 to compensate for the surface flaws to ensure a proper seal between the line generator 10 and the attachment surface.

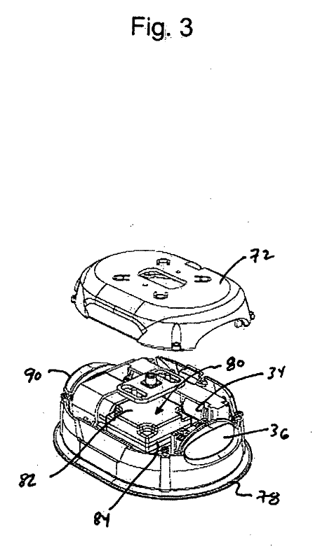

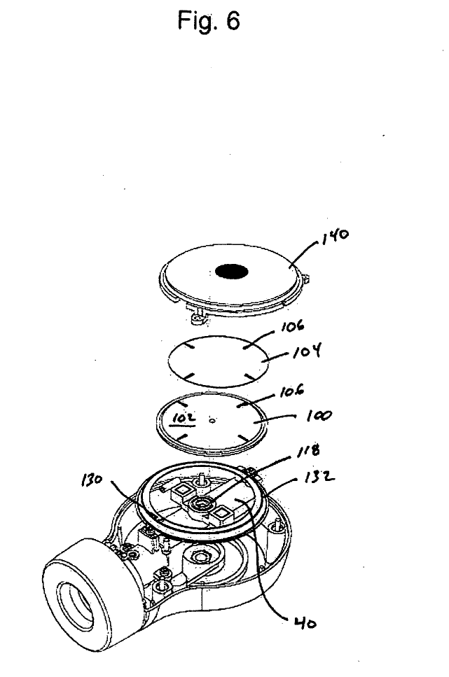

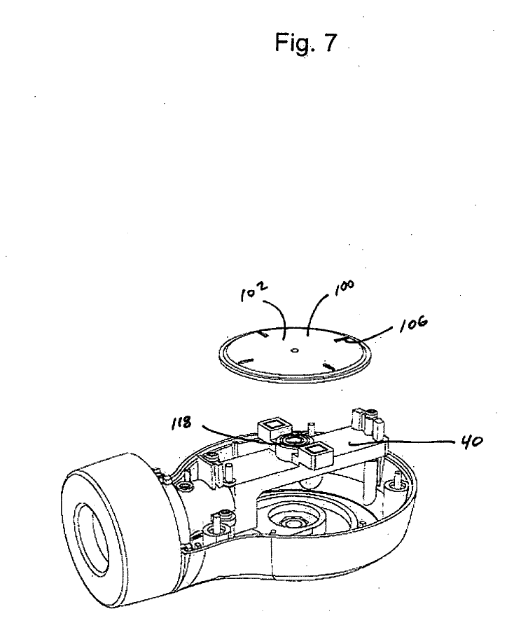

FIGS. 6-9 show another embodiment of a laser level 1 incorporating the self-leveling lens aspect of the present invention. In this embodiment, the housing includes two portions that engage each other to form the housing. In this embodiment, there is only a single housing and it is mountable to a surface in the same manner described above with respect to the embodiment shown in FIGS. 1-5. It will be understood that this laser level does not have the pivoting feature described above with respect to the laser level of FIGS. 1-5. Further details of a suitable housing and vacuum generating mechanism can be found in U.S. Ser. No. 10/919,708 published as US 2006/0037202, the entire contents of which are incorporated herein by reference.

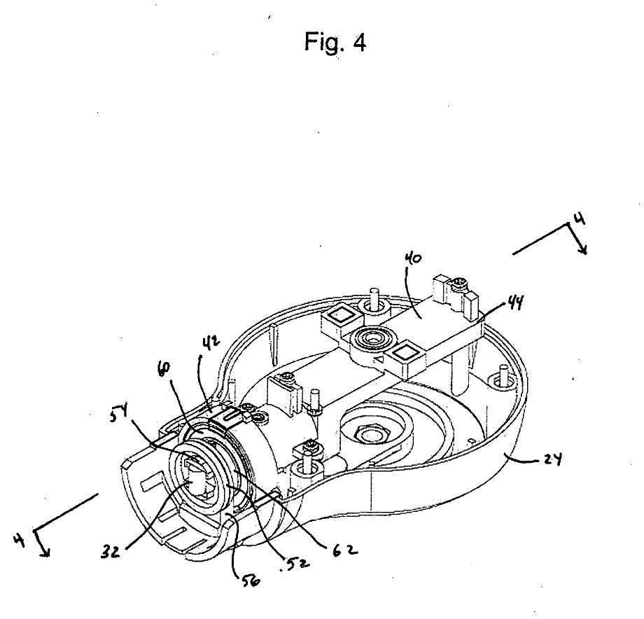

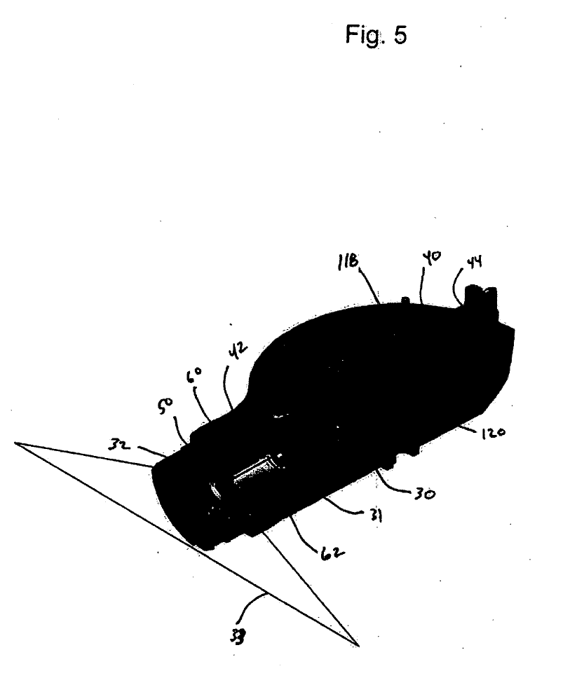

Turning now to FIGS. 4 and 5, one aspect of the self-leveling line generator 10 of the present invention is shown in connection with a first or top housing 20 formed of a first or top portion 22 and a second or bottom portion 24. The figures show the top portion 22 removed. A chassis 40 is fixed to either or both of the top 22 and bottom 24 portion. The chassis 40 fixedly holds the light source 30 with respect to the housing 20. In other words, the light source 30 does not move with respect to the housing 20. Of course, if the housing 20 is moved then the light source 30 moves. In the instance where a second housing 70 is provided and the first housing 20 is rotatable with respect to the second housing 70, the chassis 40 remains fixed with respect to the first housing 20 but will of course rotate with the first housing 20 as it rotates with respect to the second housing 70.

In the particular embodiment illustrated in FIGS. 1-5, the first housing 20 may have a generally circular shape with a cylindrical barrel 26 extending outward from the periphery of the housing. Of course, the first housing 20 may have any suitable and desired shape such that the structural components relating to the generation of a planar light beam and the mounting of the line generator can be contained within. The chassis 40 has a first end 42 and a second end 44. The chassis 40 is fixed to one of the top 22 or bottom 24 portions of the housing 20, or both. The first end 42 of the chassis fixedly holds the light source 30. In other words, the light source 30 does not move with respect to the chassis 40. The light source 30 is desirably a laser light source that includes at least one diode that projects an alignment beam toward the lens 32 to convert the beam into a planar beam of light, which is emitted from the first housing 20 in a fixed orientation. The lens 32 is desirably located in the barrel 26 so that the user is provided with a visible indication of the source of the laser light. The lens 32 is rotatable with respect to the light source 30 so that the projected planar beam of light is in a fixed orientation despite the orientation of the housing 20.

The lens 32 may have any suitable shape to convert the laser beam 31 of light into a planar beam 33 of light. For example, the lens 32 may be cylindrical. Depending on the orientation of the lens 32, the projected beam 33 will have a selected orientation. Two known and desired orientations are horizontal and vertical. Therefore, the lens 32 may be oriented to provide one of a horizontal or vertical line despite the fact that the housing 20 and, in the instance where the lens 32 is in the barrel 26, the barrel 26 is not oriented exactly horizontally or vertically. For example, FIG. 5 shows the lens 32 oriented such that the projected planar beam 33 is in horizontal direction when the bottom of the housing 20 is aligned with a horizontal or substantially horizontal surface.

The first end of the chassis 42 extends into the barrel 26 toward the distal end 28 of the barrel. A lens holder 50 holds the lens 32 in a position so that the light beam 31 emitted from the laser light source 30 contacts the lens 32, which converts the light beam 31 into a planar beam 33. The lens holder 50 is rotatable with respect to the light source 30. As shown in FIGS. 4 and 5, the first end 42 of the chassis includes a fixed bearing 60 in which the lens holder 50 is rotatably mounted. The fixed bearing 60 may be monolithic with the chassis 40 or may be separate as shown in FIGS. 4 and 5. In one embodiment, the lens holder 50 is attached to a shaft 62, which is rotatably mounted within the bearing 60 so that the lens 32 will be rotatable with respect to the light source 30. The shaft 62 is hollow to permit the light beam 31 from the light source 30 to pass through the shaft 62 to contact the lens 32. The shaft 62 may be formed monolithically with the lens holder 50 or may be separate as shown in FIGS. 4 and 5.

To provide free rotation between the lens holder 50 and the chassis 40, each of the bearing 60 and the shaft 62 are circular. In addition, to provide the desired self-leveling capability, the lens holder 50 has a pendulous structure. In one aspect, the lens holder 50 has at least a portion that has circular cross section 52 that is complementary to the shape of the bearing 60 to allow the lens holder 50 to freely rotate within the bearing 60. A forward portion of the lens holder has a pair of opposing flanges 54 in which the lens 32 can be fixedly held. An arm 56 extends from an outer periphery of the circular portion of the lens holder 50 to provide a weighted structure. The arm 56 may also have an additional weight 58 that extends from the distal end of the arm toward the bearing 60 and that is shaped to approximate the shape of the bearing 60. In other words, the additional weight 58 may have an arc shape. As a result, the lens holder 50 will swing under the influence of gravity and come to rest at a position so that the projected planar beam 33 is in a fixed orientation.

A laser light source actuation switch 36 extends through the housing. A power source 34 disposed in the housing can power both the motor 82, if provided, and the laser light source 30. In one aspect of the present invention, the power source 34 is a rechargeable battery pack, such as a lithium ion or nickel cadmium power cell securely mounted within housing. Alternatively, the power source is a removable alkaline battery or batteries. The laser light source actuation switch 36 may be separate from the motor actuation switch 90. Alternatively, a single switch may be provided to activate each of the motor 82 and the light source 30.

Referring now to FIGS. 9-12, another aspect of the present invention is illustrated. In this aspect, a cylindrical bearing 160 is fixed and the lens holder 150 has a first end that is circular 152 and that freely rotates within the bearing 160. The lens holder 150 has a second end 151 configured to hold a lens 32 that receives the light beam 31 and converts it into a projected planar light beam 33. The lens holder 150 is also configured to be weighted along a portion of its structure so that the weighted portion will seek the lowest level under the influence of gravity. In other words, the lens holder 150 will act like a pendulum to fix the lens 32 in a desired location to provide a desired fixed orientation of the planar light beam 33.

Turning now to FIGS. 6-8, the gravity dial of the present invention is shown. The gravity dial has a top surface and a bottom surface with a flange provided at a portion of the periphery of the dial. The flange receives an adjustable weight that can be used to calibrate the dial, as further explained below. The dial is rotatably mounted with respect to the housing. As a result, when the housing is attached to a vertical surface (or a substantially vertical surface), the dial will pivot with respect to the housing because of the influence of gravity on the weight. In other words, when the plane of the top surface of the dial is vertical or substantially vertical, the dial acts as a pendulum and pivots with respect to the housing.

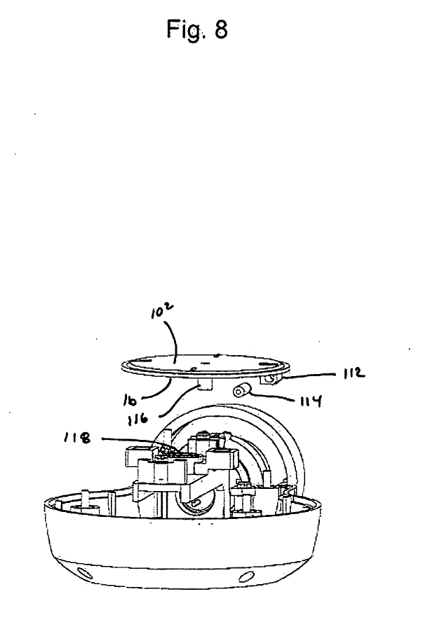

The bottom surface is provided with one of a shaft or a bearing to cooperate with a respective bearing or shaft provided in the housing. For example, as seen in FIG. 8, a shaft is rotatably provided in a bearing that is mounted in the housing to allow the dial to freely rotate. The bearing is positionally fixed with respect to the housing to allow the dial to rotate with respect to the housing. In the embodiment, shown in FIGS. 6-8, a chassis is fixed to the housing and the bearing is fixed on the chassis. In the embodiment shown in FIGS. 9-12, a chassis is fixed to the housing and a positioning pin extends toward the dial to carry a bearing in a fixed position with respect to the housing. The bottom surface of the dial has a shaft that is rotatably received by the bearing that allows the dial to freely rotate.

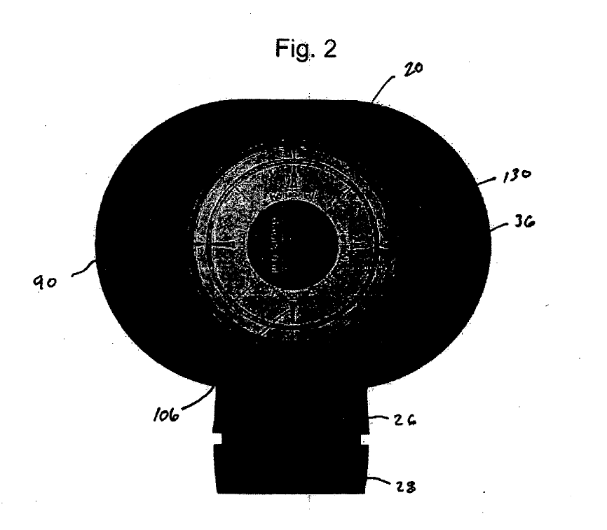

The top surface is provided with at least one visible indicator. The at least one indicator may be provided directly on the top surface. Alternatively, the at least one indicator may be provided on a plate that is attached to the top surface. The at least one indicator may also be provided on both the dial and the plate. The at least one indicator may have any suitable shape and size but is desirably an arrow shaped projection. In addition, alphanumerical characters may be provided on the top surface to aid the user in understanding the orientation of the housing. For example, as seen in FIG. 2, the top surface contains four arrow shaped projections as well as the words “horizontal” and “vertical” associated with respective arrows.

The housing is provided with at least one indicator that cooperates with the at least one indicator provided on the gravity dial to provide an indication to the use that the projected planar beam is in a desired orientation selected from one of horizontal or vertical. Desirably, the at least one indicator on the dial is aligned with at least one indicator on the housing when the housing is in a vertical or horizontal position. For example, as seen in FIG. 2, the arrow shaped projections on the gravity dial are aligned with respective indicators on the housing. The alignment of the indicators can be calibrated using the adjustable weight during assembly of the line generator.

The indicators on the housing can be provided directly on the housing or they may be provided on a stationary ring that surrounds the dial. As seen in FIG. 6, a stationary ring has flanges that can be used to fix the ring to the housing. The top of the ring is provided with at least one indicator that cooperates with the at least one indicator provided on the dial. A cap made from, for example, transparent plastic may be provided to protect the dial from dust and foreign objects yet allow the user to view the indicators on the dial.

The above description is not to be used to limit the claims and one skilled in the art will understand that various alterations and changes can be made without altering the scope of the claimed invention.

What is claimed:

1. A line generator comprising:
a. a housing carrying at least one light source for emitting a planar light beam, the housing including a bottom mounting surface and a top viewable surface opposite the mounting surface;
b. a circular gravity dial adjacent the top surface and being weighted along a portion of its arc and rotatable with respect to the housing, the dial further having at least one indicator, wherein when the mounting surface is substantially vertical, the weighted disc will self level under the influence of gravity and the at least one indicator will indicate whether the emitted light beam is in a predetermined orientation selected from one of a vertical line or a horizontal line.

2. The line generator of claim 1 further comprising at least one stationary indicator provided at the top surface and aligned along a plane of the planar light beam, wherein when the emitted light beam is in a predetermined orientation selected from one of a vertical line or a horizontal line, the at least one dial indicator is aligned with at least one stationary indicator.

3. The line generator of claim 1 further including a lock for locking the gravity dial from rotation with respect to the housing.

4. The line generator of claim 1 wherein the gravity dial is disc shaped with the at least one indicator provided on a top surface and a shaft extending from a bottom surface.

5. The line generator of claim 4 wherein the shaft engages a bearing that is non-rotatably mounted within the housing.

6. The line generator of claim 2 wherein the stationary indicator is provided on a ring surrounding the dial.

7. The line generator of claim 1 further comprising a vacuum generating mechanism disposed within the housing and cooperating with the mounting surface.

8. The line generator of claim 1 wherein the light source includes a laser diode for emitting a laser beam along a first path and a lens disposed in the path for converting the laser beam into a planar beam.

9. The line generator of claim 8 wherein the lens is rotatable with respect to the laser diode about an axis defined by the first path.

10. The line generator of claim 1 further comprising:
a. a bottom portion including the mounting surface;
b. a top portion including the top viewable surface and being pivotable with respect to the bottom portion.

11. The line generator of claim 10 wherein further comprising a lock for fixing the top portion relative to the bottom portion.

12. The line generator of claim 10 wherein the light source is disposed within the top portion.
